(19) United States
(12) Patent Application Publication
(10) Pub. No.: US 2026/0088350 A1
(43) Pub. Date: Mar. 26, 2026

(54) POLYMER ELECTROLYTE FOR LITHIUM SECONDARY BATTERIES, MANUFACTURING METHOD THEREOF AND LITHIUM SECONDARY BATTERY COMPRISING THE SAME

(71) Applicant: UIF (University Industry Foundation), Yonsei University, Seoul (KR)

(72) Inventors: Sang-Young LEE, Seoul (KR); Hyunseok Moon, Seoul (KR); Dong Yeob Han, Seoul (KR)

(73) Assignee: UIF (University Industry Foundation), Yonsei University, Seoul (KR)

(21) Appl. No.: 19/334,412

(22) Filed: Sep. 19, 2025

(30) Foreign Application Priority Data
Sep. 20, 2024 (KR) 10-2024-0127107
Sep. 9, 2025 (KR) 10-2025-0128306

(51) Int. Cl. H01M 10/0565; H01M 10/052; H01M 50/426

(52) U.S. Cl. CPC H01M 10/0565; H01M 10/052; H01M 50/426; H01M 2300/0082

(57) ABSTRACT

The present invention relates to a polymer electrolyte for lithium secondary batteries, a method for manufacturing the same, and a lithium secondary battery comprising the same. More specifically, the polymer electrolyte composition for lithium secondary batteries of the present invention has the advantage of being able to secure excellent ionic conductivity at room temperature and excellent electrochemical stability by mixing a polymer resin including a monomer having one or more double bonds, a lithium salt, and an initiator with a specific dispersant that does not dissolve the polymer resin and lithium salt but has excellent dispersibility, and then polymerizing the mixture to prepare a polymer electrolyte, thereby lowering the crystallinity within the polymer electrolyte. Furthermore, by applying this to a lithium secondary battery, the full capacity of the active material in the battery can be exhibited, thereby significantly improving charge/discharge efficiency, Coulombic efficiency, specific capacity, and cycle life characteristics.

### CROSS-REFERENCE TO RELATED APPLICATION

This application claims priorities to Korean Patent Applications Nos. 10-2024-0127107 and 10-2025-0128306, filed on Sep. 20, 2024 and Sep. 9, 2025, respectively, and all the benefits accruing therefrom under 35 U.S.C. § 119, the contents of which in its entirety are herein incorporated by reference.

### BACKGROUND

### 1. Field

The present invention relates to a polymer electrolyte for lithium secondary batteries, a manufacturing method thereof, and a lithium secondary battery comprising the same.

### 2. Description of the Related Art

Existing lithium-ion batteries using liquid electrolytes have reached the limit of energy density increase, and safety issues are constantly being raised. To solve these problems, all-solid-state batteries using solid electrolytes are drawing attention. Among them, polymer electrolytes are attracting attention as core materials for next-generation batteries that can replace lithium-ion batteries because they have lower density compared to inorganic solid electrolytes and excellent interfacial stability between the electrode and the electrolyte.

However, polymer-based all-solid-state batteries have a disadvantage in that they exhibit low ionic conductivity characteristics at room temperature, and thus exhibit performance comparable to liquid electrolytes only at high temperatures of 60° C. or higher. Therefore, there are still significant limitations in realizing practical batteries.

### REFERENCES

1. Korean Laid-open Patent No. 2024-0037591

### SUMMARY

To solve the above problems, the present invention aims to provide a polymer electrolyte for lithium secondary batteries that can secure excellent ionic conductivity at room temperature and has excellent electrochemical stability.

The present invention also aims to provide a separator for lithium secondary batteries comprising the polymer electrolyte according to the present invention.

The present invention also aims to provide a lithium secondary battery that significantly improves charge/discharge efficiency, Coulombic efficiency, specific capacity, and cycle life characteristics by exhibiting the full capacity of active materials in the battery, by including the polymer electrolyte according to the present invention.

The present invention also aims to provide a device comprising a lithium secondary battery according to the present invention, wherein the device is any one selected from a communication device, a transportation device, and an energy storage device.

The present invention also aims to provide a method for manufacturing a polymer electrolyte for lithium secondary batteries.

The present invention provides a polymer electrolyte for lithium secondary batteries formed by polymerizing a polymer electrolyte composition comprising (i) a monomer including one or more double bonds, (ii) a carbonate-based compound, (iii) a lithium salt, and (iv) a dispersant having a dielectric constant of 10 or less.

The monomer may be an imide-based monomer, the polymerization may be thermal polymerization or photopolymerization, and the polymer electrolyte composition may further comprise an initiator.

The present invention also provides a separator for lithium secondary batteries comprising the polymer electrolyte according to the present invention.

The present invention also provides a lithium secondary battery comprising the polymer electrolyte according to the present invention.

The present invention also provides a device comprising a lithium secondary battery according to the present invention, wherein the device is any one selected from a communication device, a transportation device, and an energy storage device.

The present invention also provides a method for manufacturing a polymer electrolyte for lithium secondary batteries, comprising: (i) preparing a polymer electrolyte composition comprising a monomer including one or more double bonds, (ii) a carbonate-based compound, (iii) a lithium salt, and (iv) a dispersant having a dielectric constant of 10 or less; impregnating or coating a substrate with the polymer electrolyte composition; and polymerizing the impregnated or coated polymer electrolyte composition to prepare a polymer electrolyte.

he polymer electrolyte composition for lithium secondary batteries of the present invention has the advantage of being able to secure excellent ionic conductivity at room temperature and excellent electrochemical stability by mixing (i) a monomer having one or more double bonds, (ii) a carbonate-based compound, and (iii) a lithium salt with (iv) a specific dispersant that does not dissolve the monomer and the lithium salt but has excellent dispersibility, and then polymerizing the mixture to prepare a polymer electrolyte, thereby lowering the crystallinity within the polymer electrolyte.

Furthermore, by applying this to a lithium secondary battery, the full capacity of the active material in the battery can be exhibited, thereby significantly improving charge/discharge efficiency, Coulombic efficiency, specific capacity, and cycle life characteristics.

The effects of the present invention are not limited to those mentioned above. The effects of the present invention should be understood to include all effects inferable from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a lithium secondary battery comprising a polymer electrolyte according to the present invention for a lithium secondary battery.

FIG. 2 is a diagram comparing the active material activation degree of a conventional general polymer electrolyte and a polymer electrolyte according to the present invention.

FIG. 3 is a graph of ionic conductivity of the polymer electrolytes prepared in Examples 1 to 5 according to the present invention.

FIG. 4 is a graph showing the results of capacity retention rate and Coulombic efficiency measurements for 180 cycles at room temperature (25° C.) for the LFP∥Li secondary battery manufactured in Example 6 according to the present invention.

FIG. 5 is a graph showing the results of specific capacity measurements at room temperature (25° C.) for the LFP∥Li secondary battery manufactured in Example 6 according to the present invention.

FIGS. 6A and 6B are small-angle X-ray scattering analysis results for five electrolytes (PIS, PEO, MIS, MIS+DME, MIS+F-toluene, respectively) prepared in Comparative Examples 1 to 4 and Example 7, and FIG. 6C is the result of domain size calculation based thereon.

FIGS. 7A and 7B respectively show the crosslinking status of the polymer electrolytes prepared in the Examples and Comparative Examples.

### DETAILED DESCRIPTION

Hereinafter, the present invention will be described in more detail.

The present invention relates to a polymer electrolyte for lithium secondary batteries, a method for manufacturing the same, and a lithium secondary battery comprising the same.

As described above, existing polymer-based all-solid-state batteries have low ionic conductivity characteristics at room temperature, and thus had the disadvantage of exhibiting performance comparable to liquid electrolytes only at high temperatures of 60° C. or higher.

Accordingly, in the present invention, a polymer electrolyte is prepared by mixing (i) a monomer having one or more double bonds, (ii) a carbonate-based compound, and (iii) a lithium salt with (iv) a specific dispersant that does not dissolve the monomer and the lithium salt but has excellent dispersibility, and then polymerizing the mixture, thereby lowering the crystallinity within the polymer electrolyte to secure excellent ionic conductivity at room temperature, and having the advantage of excellent electrochemical stability. Furthermore, the invention was completed by realizing that by applying this to a lithium secondary battery, the full capacity of the active material in the battery can be exhibited, thereby significantly improving charge/discharge efficiency, Coulombic efficiency, specific capacity, and cycle life characteristics.

Specifically, the present invention provides a polymer electrolyte for lithium secondary batteries formed by polymerizing a polymer electrolyte composition comprising (i) a monomer having one or more double bonds, (ii) a carbonate-based compound, (iii) a lithium salt, and (iv) a dispersant having a dielectric constant of 10 or less.

Preferably, the monomer may be an imide-based monomer.

In addition, the polymerization may be thermal polymerization or photopolymerization, and the polymer electrolyte composition may further comprise an initiator.

The imide-based monomer may be mixed to improve the dissociation characteristics of the lithium salt by polymerizing to form a polyimide-based polymer, and has the advantage of excellent thermal stability characteristics.

Specific examples of the imide-based monomer may be one or more selected from the group consisting of 1-ethyl-3-methylimidazolium bis(trifluoromethylsulfonyl)imide, N-methyl-N-propylpyrrolidinium bis(trifluoromethanesulfonyl)imide, N-butyl-N-methylpyrrolidium bis(3-trifluoromethylsulfonyl)imide, and 1-butyl-3-methylimidazolium bis(trifluoromethylsulfonyl)imide.

Preferably, the imide-based monomer may be 1-ethyl-3-methylimidazolium bis(trifluoromethylsulfonyl)imide, 1-butyl-3-methylimidazolium bis(trifluoromethylsulfonyl)imide, or a mixture thereof, and most preferably, it may be 1-ethyl-3-methylimidazolium bis(trifluoromethylsulfonyl)imide.

The carbonate-based compound is a compound that can participate as a monomer with the imide-based monomer to form a polymer structure, has excellent miscibility with the imide-based monomer or the polyimide-based polymer, can be mixed to improve the capacity retention characteristics and cycle characteristics of the battery, and has a high dielectric constant and low viscosity, thereby further improving room temperature ionic conductivity.

The carbonate-based compound may be one or more selected from the group consisting of allyl methylene carbonate, allyl ethylene carbonate, divinyl carbonate, vinylene carbonate, vinylethylene carbonate, and vinylmethyl carbonate.

Preferably, the carbonate-based compound may be one or more selected from the group consisting of vinylethylene carbonate, vinylene carbonate, and vinylmethyl carbonate, and most preferably, it may be vinylethylene carbonate.

The monomer and the carbonate-based compound may be mixed in a molar ratio of 1:2-6, preferably 1:3-5, and most preferably 1:3.5-4.5. At this time, if the molar ratio is less than 1:2, the capacity retention rate and cycle characteristics of the battery may decrease, and conversely, if it exceeds 1:6, the miscibility with the imide-based monomer or the polyimide-based polymer may be poor, and the ionic conductivity may be significantly reduced.

The lithium salt may be one or more selected from the group consisting of LiPF6, LiBF4, LiSbF6, LiAsF6, LiGO, LiFSI, LiCl, LiBr, LiI, LiB10Cl10, LiCF3SO3, LiCF3CO2, LiAlCl4, CH3SO3Li, LiSCN, LiOH·H2O, LiBOB, LiN(C2F5SO2)2, LiN(CF3SO2)2, CF3SO3Li, LiC(CF3SO2)3, LiC4BO8, LiTFSI, and LiClO4. Preferably, the lithium salt may be one or more selected from the group consisting of LiFSI, LiCl, LiPF6, LiBF4, and LiTFSI, and preferably, it may be LiFSI.

The molar ratio of (monomer+carbonate-based compound):lithium salt in the polymer electrolyte composition may be 1-3:1, preferably 1.3-2.8:1, and most preferably 1.8-2.2:1. At this time, if the molar ratio is less than 1:1, the lithium salt may not be sufficiently ionized in the electrolyte, and conversely, if it exceeds 3:1, the ionic conductivity of lithium ions may decrease, leading to poor charge/discharge performance of the battery.

Conventional polymer electrolytes are composed of a mixture of lithium salt and polymer material, and have structural characteristics divided into amorphous regions and crystalline regions, exhibiting low ionic conductivity at room temperature. In addition, generally, ions in a polymer electrolyte can conduct in both amorphous and crystalline regions, but the movement of ions by segmental motion may be faster in the amorphous region.

In the present invention, by mixing a dispersant having a dielectric constant of 10 or less, the crystallinity within the polymer electrolyte can be lowered, thereby further expanding the amorphous region of the polymer electrolyte and homogenizing the ionic conduction network.

Furthermore, the dispersant must have excellent dispersibility while not dissolving the monomer, carbonate-based compound, and lithium salt. If a solvent capable of dissolving one or more of the monomer, carbonate-based compound, and lithium salt, such as dimethyl ether (DME), is used instead of the dispersant according to the present invention, it can form a solvated structure through interaction with one or more of the monomer, carbonate-based compound, and lithium salt, thereby forming even larger domains, and thus the effects of the present invention cannot be achieved at all.

The dispersant according to the present invention has excellent dispersibility while not dissolving the monomer, carbonate-based compound, and lithium salt, and through these characteristics, it can increase the entropy of the polymer electrolyte system, reduce the size of local electrolyte domains, and homogenize the channels through which lithium ions can move, thereby promoting the movement of lithium ions between the electrode and the electrolyte and increasing the activity of the electrode.

It is preferable to use a dispersant having a dielectric constant of 10 or less, preferably 5 or less. If the dielectric constant of the dispersant exceeds 10, the dispersibility of the polymer resin may decrease, leading to an increase in crystallinity within the polymer electrolyte, and consequently, the ionic conductivity characteristics at room temperature may not meet the expected level.

Specific examples of the dispersant may be one or more selected from the group consisting of 1,1,2,2-tetrafluoroethyl-2,2,3,3-tetrafluoropropyl ether (hereinafter referred to as ‘TTE’), 2,2-bis(trifluoromethyl)-1,3-dioxolane (TFDOL), trifluoroethyl phosphite (TFEPi), trifluoroethyl phosphate (TFEPa), 1,1,2,2-tetrafluoroethyl-2,2,2-trifluoroethyl ether, monofluorobenzene (FB), difluorobenzene, trifluorobenzene, tetrafluorobenzene, pentafluorobenzene, hexafluorobenzene, 1,1,2,2-tetrafluoro-3-(1,1,2,2-tetrafluoroethoxy)propane, methyl difluoroacetate ethyl difluoroacetate, difluoroethyl acetate, 3,5-bistrifluoromethyltoluene, and trifluorotoluene (hereinafter referred to as ‘F-toluene’).

Preferably, the dispersant may be one or more selected from the group consisting of trifluorotoluene (F-toluene), 1,1,2,2-tetrafluoroethyl-2,2,3,3-tetrafluoropropyl ether (TTE), 1,1,2,2-tetrafluoro-3-(1,1,2,2-tetrafluoroethoxy)propane, and 1,1,2,2-tetrafluoroethyl-2,2,2-trifluoroethyl ether, and most preferably, it may be trifluorotoluene (F-toluene) or 1,1,2,2-tetrafluoroethyl-2,2,3,3-tetrafluoropropyl ether (TTE).

The dispersant may be included in an amount of 10-50 vol % based on 100 vol % of the mixed volume of (the monomer+the carbonate-based compound+the lithium salt). At this time, if the content of the dispersant is less than 10 vol %, the room temperature ionic conductivity at 25° C. may not meet the expected level, and the charge/discharge performance of the battery may be significantly degraded. Conversely, if it exceeds 50 vol %, the cross-linking reaction of the polymer resin may be impossible, and the polymer electrolyte may not be polymerized.

The amount of dispersant used may vary depending on the type of dispersant component, and according to the present invention, after preparing a liquid polymer electrolyte composition by mixing a polymer monomer, a carbonate-based compound, a lithium salt, a dispersant, and an initiator if necessary, the amount of dispersant can be determined so that the polymer electrolyte obtained by polymerizing it satisfies the following three conditions.
\textcircled{1} Ionic conductivity of 2×10⁻⁴ S/cm or more,
\textcircled{2} Overvoltage of 40 mV or less in terms of stability with lithium metal, and
\textcircled{3} Oxidation stability of 4.5 V vs. Li/Li+ or more at high voltage.

In particular, it is preferable that the dispersant is trifluorotoluene (F-toluene) or 1,1,2,2-tetrafluoroethyl-2,2,3,3-tetrafluoropropyl ether (TTE), and more preferably, trifluorotoluene (F-toluene) is introduced at 15-25 vol % or 1,1,2,2-tetrafluoroethyl-2,2,3,3-tetrafluoropropyl ether (TTE) is introduced at 35-45 vol %, based on 100 vol % of the mixed volume of (the monomer+the carbonate-based compound+the lithium salt).

In the case of the embodiments described as more preferable above, stress due to differences in thermal expansion coefficient or mechanical strength between the polymer electrolyte and the electrode, and cracks or delamination during use due to this, are significantly reduced, whereas in other cases, these effects are not exhibited.

The initiator may be one or more selected from the group consisting of azobisisobutyronitrile (AIBN), azobisdimethylvaleronitrile (ADMVN), dilauroyl peroxide (DLP), benzoyl peroxide (BPO), acetyl peroxide, t-butyl peracetate, cumyl peroxide, t-butyl peroxide, t-butyl hydroperoxide, and bis(4-tert-butylcyclohexyl) peroxydicarbonate. Preferably, the initiator may be azobisisobutyronitrile, azobisdimethylvaleronitrile, or a mixture thereof, and most preferably, it may be azobisisobutyronitrile.

The initiator may be included in an amount of 1-5 wt %, preferably 1.6-4 wt %, and most preferably 2-3 wt %, based on 100 wt % of the mixed weight of (the monomer+the carbonate-based compound).

The thickness of the polymer electrolyte may be 20-100 μm, preferably 20-50 μm, and most preferably 20-30 μm. At this time, if the thickness of the polymer electrolyte is less than 20 μm, the mechanical properties may decrease, and conversely, if it exceeds 100 am, the migration path of lithium ions becomes too long, which may lead to a decrease in room temperature ionic conductivity.

The ionic conductivity of the polymer electrolyte may be 2.8×10⁻⁴ to 3.0×10⁻³ S/cm, preferably 3.1×10⁻⁴ to 1.0×10⁻³ S/cm, more preferably 3.4×10⁻⁴ to 9.0×10⁻⁴ S/cm, and most preferably 4.0×10⁻⁴ to 7.0×10⁻⁴ S/cm at 25° C.

Furthermore, the polymer electrolyte according to a preferred embodiment of the present invention has a domain size of less than 10 nm according to small-angle X-ray scattering (SAXS) analysis.

The fact that the domain size of the polymer electrolyte is less than 10 nm is significant in that it has not been reported to date and is a size that can only be secured according to the manufacturing method of the present invention. Furthermore, domains less than 10 nm contribute to forming small and uniform domain structures and increase the connectivity of these domain structures, thereby forming low-resistance lithium ion transport channels within the electrolyte, whereas in domains exceeding 10 nm, uniform and low-resistance transport channels are not formed within the electrolyte, which is also significant.

The polymer electrolyte has electrolyte domains of amorphous regions and crystalline regions uniformly dispersed, forming uniform and continuous lithium ion conduction channels within the electrolyte domains, and lithium ions can be uniformly located within the electrolyte structure. That is, the polymer electrolyte is polymerized according to the manufacturing method of the present invention, such as using a dispersant with excellent dispersibility while not dissolving the polymer resin and lithium salt, so that the electrolyte domains of the amorphous regions and crystalline regions are small and uniformly dispersed, thereby homogenizing the migration channels of lithium ions within such an electrolyte structure.

According to a preferred embodiment, polymer electrolytes were prepared under different conditions and analyzed. As a result, it was confirmed that, unlike other conditions and other numerical ranges, when all of the following conditions were satisfied, inter-particle channels were formed through cascade-shaped or hierarchically arranged fine domain structures, and ion transport efficiency was maximized, whereas if any one of the following conditions was not satisfied, these effects are not exhibited.

\textcircled{1} monomer is 1-ethyl-3-methylimidazolium bis(trifluoromethylsulfonyl)imide, \textcircled{2} the carbonate-based compound is vinylethylene carbonate, \textcircled{3} the molar ratio of the monomer:the carbonate-based compound is 1:3-5, \textcircled{4} the molar ratio of (the monomer+the carbonate-based compound):lithium salt is 1.3-2.8:1 molar ratio, and \textcircled{5} the dispersant is trifluorotoluene (F-toluene) or 1,1,2,2-tetrafluoroethyl-2,2,3,3-tetrafluoropropyl ether.

According to another preferred embodiment, polymer electrolytes were prepared under different conditions and analyzed. As a result, it was confirmed that, unlike other conditions and other numerical ranges, when all of the following conditions were satisfied, mechanical stress within the battery was alleviated and impact resistance was improved due to the flexibility of the polymer electrolyte, and the polymer chains present in the electrolyte were optimally arranged, optimizing the ion diffusion pathway, whereas if any one of the following conditions was not satisfied, these effects are not exhibited.

\textcircled{1} The monomer is 1-ethyl-3-methylimidazolium bis(trifluoromethylsulfonyl)imide, \textcircled{2} the carbonate-based compound is vinylethylene carbonate, \textcircled{3} the molar ratio of the monomer:the carbonate-based compound is 1:3.5-4.5, \textcircled{4} the molar ratio of (the monomer+the carbonate-based compound):the lithium salt is 1.8-2.2:1, \textcircled{5} the dispersant is trifluorotoluene (F-toluene) or 1,1,2,2-tetrafluoroethyl-2,2,3,3-tetrafluoropropyl ether, and \textcircled{6} the dispersant is included at 15-25 vol % of trifluorotoluene (F-toluene) or 35-45 vol % of 1,1,2,2-tetrafluoroethyl-2,2,3,3-tetrafluoropropyl ether (TTE) based on 100 vol % of the mixed volume of (the monomer+the carbonate-based compound+the lithium salt).

The present invention also provides a separator for lithium secondary batteries comprising the polymer electrolyte according to the present invention.

The present invention also provides a lithium secondary battery comprising the polymer electrolyte according to the present invention.

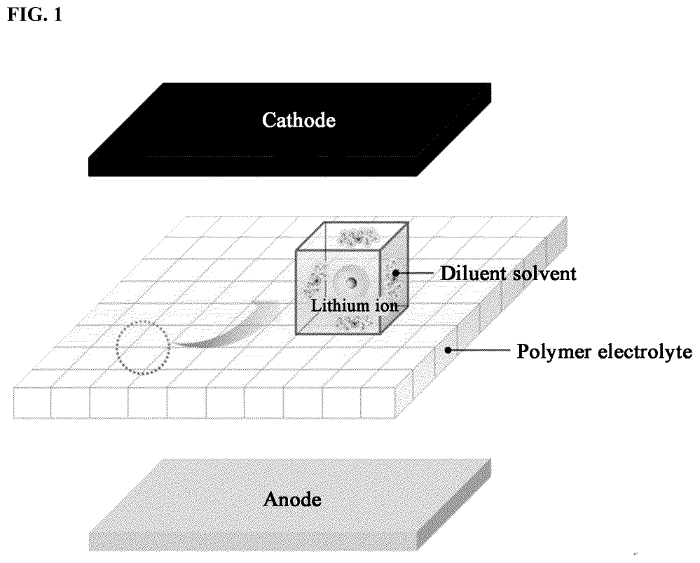

FIG. 1 is a schematic diagram of a lithium secondary battery comprising a polymer electrolyte for a lithium secondary battery according to the present invention. Referring to FIG. 1, it shows a lithium secondary battery having a structure in which the polymer electrolyte is interposed between the anode and the cathode. The polymer electrolyte is polymerized with a dispersant (diluent solvent) having excellent dispersibility, so that electrolyte domains of amorphous regions and crystalline regions are uniformly dispersed, forming uniform and continuous lithium ion conduction channels within the electrolyte domains, and lithium ions are uniformly located within the electrolyte structure, showing that the migration channels of lithium ions are homogenized.

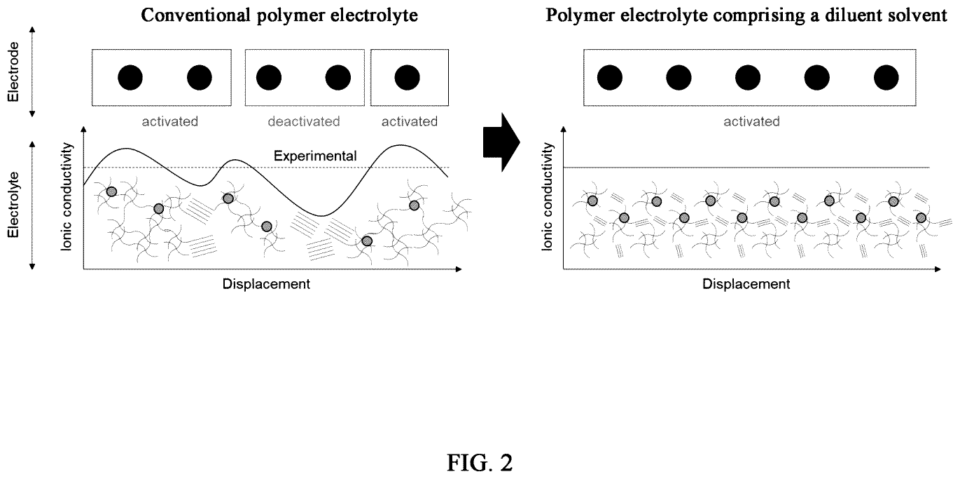

FIG. 2 is a diagram comparing the active material activation degree of a conventional general polymer electrolyte and a polymer electrolyte according to the present invention. Referring to FIG. 2, the polymer electrolyte of the present invention, by including a dispersant, shows that the electrolyte domains of amorphous regions and crystalline regions within the polymer electrolyte are uniformly dispersed, thereby reducing the tortuosity of ionic conduction, homogenizing the channels through which lithium ions can move, promoting ion migration between the electrode and the electrolyte, and improving the activity of the electrode.

The present invention also provides a device comprising a lithium secondary battery according to the present invention, wherein the device is any one selected from a communication device, a transportation device, and an energy storage device.

The present invention also provides a method for manufacturing a polymer electrolyte for lithium secondary batteries, comprising: preparing a polymer electrolyte composition comprising a polymer resin including an imide-based monomer and a carbonate-based compound; a lithium salt; a dispersant having a dielectric constant of 10 or less; and an initiator; impregnating or coating a substrate with the polymer electrolyte composition; and polymerizing the impregnated or coated polymer electrolyte composition to prepare a polymer electrolyte.

The substrate may be an electrode, a separator, or an electrode and a separator.

In the step of manufacturing the polymer electrolyte, the polymerization may be thermal polymerization performed at 60-85° C. for 1-5 hours, preferably at 65-78° C. for 1.5-4 hours, and most preferably at 68-73° C. for 2-3 hours.

At this time, if the thermal polymerization temperature is less than 60° C. or the time is less than 1 hour, the polymer resin may not be properly polymerized, and conversely, if it exceeds 85° C. or the time exceeds 5 hours, the polymer resin may be excessively thermally polymerized, leading to an increase in cross-linking density and insufficient securing of lithium ion migration channels.

Hereinafter, the present invention will be described in more detail through examples, etc., but the scope and content of the present invention cannot be reduced or limited by the examples, etc., below. Furthermore, based on the disclosure of the present invention, including the examples below, it is clear that a person of ordinary skill in the art can easily implement the present invention for which specific experimental results are not presented, and it is natural that such modifications and alterations fall within the scope of the appended claims.

Furthermore, the experimental results presented below describe only representative experimental results of the examples and comparative examples, and the respective effects of various embodiments of the present invention not explicitly presented below will be specifically described in the relevant sections.

### EXAMPLES

### Examples 1 to 5 and Comparative Examples 1 to 5: Preparation of Polymer Electrolyte

AMIM-TFSI (1-ethyl-3-methylimidazolium bis(trifluoromethylsulfonyl)imide) as a polymer monomer, VEC (vinylethylene carbonate) as a carbonate-based compound, LiFSI as a lithium salt, TTE (1,1,2,2-tetrafluoroethyl-2,2,3,3-tetrafluoropropyl ether) as a dispersant, and AIBN (azobisisobutyronitrile) as an initiator were prepared.

A mixture was prepared by mixing 1 mol of LiFSI, 0.4 mol of AMIM-TFSI, and 1.6 mol of VEC. TTE was added at a volume % as shown in Table 1 below, based on 100 vol % of the mixture, and AIBN was mixed at 2 wt % based on 100 wt % of the mixed weight of AMIM-TFSI and VEC, to prepare a liquid polymer electrolyte composition.

The liquid polymer electrolyte composition was cast onto a PE separator and then thermally polymerized at 70° C. for 3 hours to prepare a polymer electrolyte with a thickness of 20-30 μm.

TABLE 1

| | Examples | | | | | Comparative Examples | | | | |
|---|---|---|---|---|---|---|---|---|---|---|
| | 1 | 2 | 3 | 4 | 5 | 1 | 2 | 3 | 4 | 5 |
| LiFSI/AMIM-TFSI/VEC | 100 | 100 | 100 | 100 | 100 | 100 | 100 | 100 | 100 | 100 |
| mixture (vol %) | | | | | | | | | | |
| TTF (vol %) | 10 | 20 | 30 | 40 | 50 | 0 | 60 | 70 | 80 | 90 |

### Example 6: Preparation of LFP∥Li Battery Based on Polymer Electrolyte

An LFP electrode and a PE separator were sequentially laminated, then the liquid polymer electrolyte composition prepared in Example 4 was poured to impregnate the electrode and separator. Next, after fabricating a battery by laminating an anode, a LFP∥Li secondary battery comprising a polymer electrolyte was manufactured by thermal polymerization at 70° C. for 3 hours.

### Comparative Example 1: Preparation of PIS (Polymer-In-Salt) Polymer Electrolyte

A polymer electrolyte composition was prepared by mixing 1 mol of LiFSI and 2 mol of polymer obtained by polymerizing AMIM-TFSI and VEC monomers. The prepared liquid polymer electrolyte composition was cast onto a PE separator, and then the solvent was completely evaporated in an oven at 70° C. for 3 hours to prepare a PIS polymer electrolyte with a thickness of 20-30 μm.

### Comparative Example 2: Preparation of PEO Commercial Polymer Electrolyte

A PEO commercial polymer electrolyte (Sigma-Aldrich, model name 181986) for use as a comparative example was purchased and prepared. A liquid polymer electrolyte composition was prepared by dissolving 1 mol of LiFSI and 2 mol of PEO commercial polymer in THF solvent. The liquid polymer electrolyte composition was cast onto a PE separator and then a PEO polymer electrolyte with a thickness of 20-30 μm was prepared at room temperature.

### Comparative Example 3: Preparation of MIS (Monomer-In-Salt) Polymer Electrolyte

1 mol of LiFSI, 0.4 mol of AMIM-TFSI, and 1.6 mol of VEC were mixed to prepare a mixture. A liquid polymer electrolyte composition was prepared by mixing AIBN at 2 wt % based on 100 wt % of the mixed weight of AMIM-TFSI and VEC.

The liquid polymer electrolyte composition was cast onto a PE separator and then thermally polymerized at 70° C. for 3 hours to prepare a MIS polymer electrolyte with a thickness of 20-30 μm.

### Comparative Example 4: Preparation of MIS+DME Polymer Electrolyte

A mixture was prepared by mixing 1 mol of LiFSI, 0.4 mol of AMIM-TFSI, and 1.6 mol of VEC. Dimethyl ether (DME) was added at 20 vol % based on 100 vol % of the mixture, and AIBN was mixed at 2 wt % based on 100 wt % of the mixed weight of AMIM-TFSI and VEC, to prepare a liquid polymer electrolyte composition.

The liquid polymer electrolyte composition was cast onto a PE separator and then thermally polymerized at 70° C. for 3 hours to prepare a MIS+DME polymer electrolyte with a thickness of 20-30 μm.

### Example 7: Preparation of MIS+F-Toluene Polymer Electrolyte

Except for the point of using trifluorotoluene (F-toluene) instead of TTE as the dispersant and the point of adding 20 vol % of the dispersant based on 100 vol % of the mixture of (the monomer+the carbonate+the lithium salt), the procedure was carried out in the same manner as in Example 4 above to prepare a MIS+F-toluene polymer electrolyte.

### Experimental Example 1: Evaluation of Room Temperature Ionic Conductivity

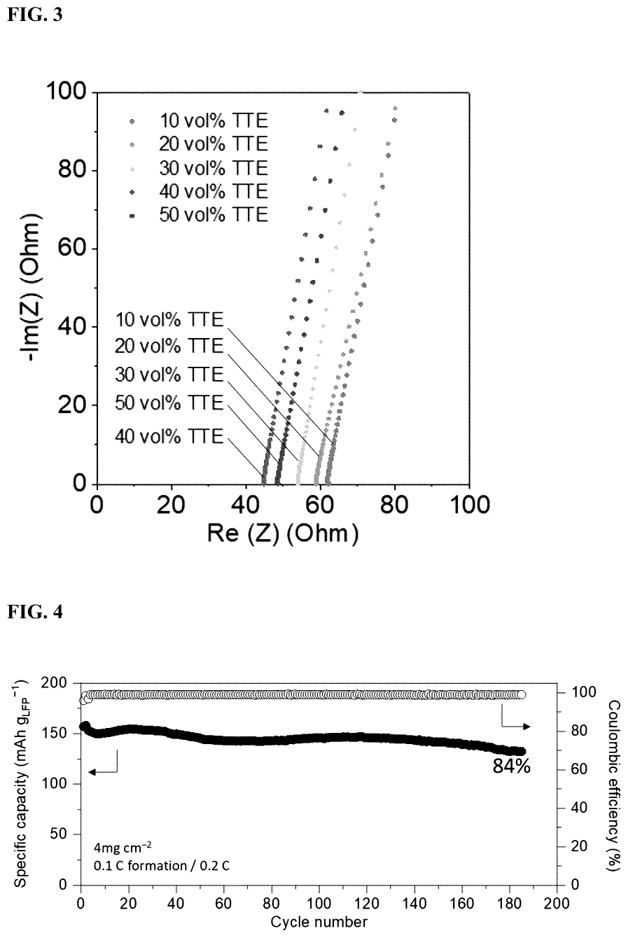

For the polymer electrolytes prepared in Examples 1 to 5 and Comparative Examples 1 to 5, the impedance and thickness of the electrolyte were measured at room temperature of 25° C. by a conventional method, and the corresponding ionic conductivity results are shown in Table 2 and FIG. 3.

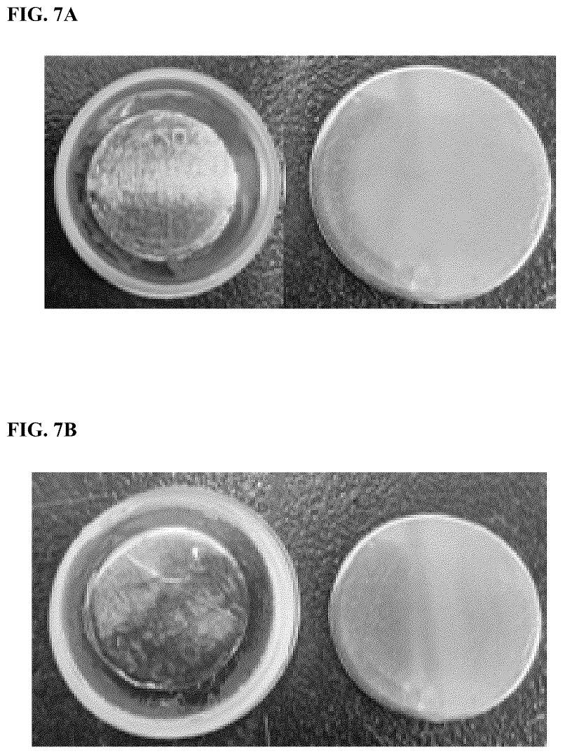

TABLE 2

| | Examples | | | | | Comparative Examples | | | | |
|---|---|---|---|---|---|---|---|---|---|---|
| | 1 | 2 | 3 | 4 | 5 | 1 | 2 | 3 | 4 | 5 |
| LiFSI/AMIM-TFSI/VEC | 100 | 100 | 100 | 100 | 100 | 100 | 100 | 100 | 100 | 100 |
| mixture (vol %) | | | | | | | | | | |
| TTF (vol %) | 10 | 20 | 30 | 40 | 50 | 0 | 60 | 70 | 80 | 90 |
| Room Temperature | 2.8 | 3.1 | 3.4 | 4.2 | 3.7 | 1.9 | — | — | — | — |
| (25° C.) | | | | | | | | | | |
| IonicConductivity | | | | | | | | | | |
| (×10⁻⁴ S/cm) | | | | | | | | | | |

| | | |
|---|---|---|
| Crosslinking Status | FIG. 7a | FIG. 7b |
| | Crosslinked | Crosslinking Not possible |

According to the results in Table 2, in the case of Examples 1 to 5, the ionic conductivity at room temperature (25° C.) was improved by at least 1.4 times or more compared to Comparative Example 1, which did not include a dispersant, by including the dispersant. In particular, in the case of Example 4, it was confirmed that the ionic conductivity increased by about 2.2 times compared to Comparative Example 1, which did not include a dispersant. Through this, it was found that by mixing a dispersant with the polymer resin, the dispersant increases the entropy of the polymer electrolyte system, reduces the size of local domains, and homogenizes the channels through which lithium ions can move, thereby improving ionic conductivity at room temperature.

On the other hand, Comparative Example 1, which did not contain any dispersant, showed relatively low ionic conductivity at room temperature compared to Examples 1 to 5, and in Comparative Examples 2 to 5, due to the excessive inclusion of the dispersant, cross-linking did not proceed, making ionic conductivity measurement impossible.

FIG. 3 is a graph of ionic conductivity of the polymer electrolytes prepared in Examples 1 to 5. Referring to FIG. 3, it shows that the most excellent ionic conduction channel was formed when 40 vol % of the dispersant was included, because salt dissociation and local domain formation were optimized.

### Experimental Example 2: Evaluation of Room Temperature Performance of Lithium Secondary Battery

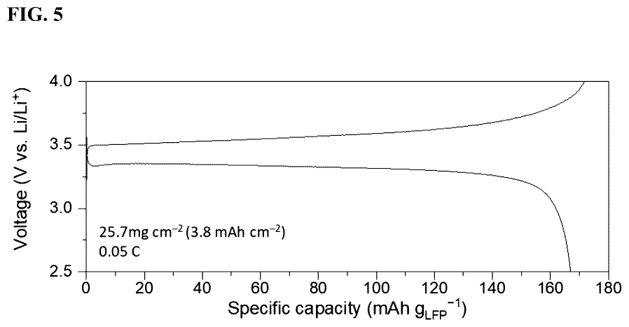

For the LFPI∥Li secondary battery prepared in Example 6, capacity retention rate, Coulombic efficiency, and specific capacity were measured for 180 cycles at room temperature of 25° C. under conditions of a cell capacity of 3.8 mAh/cm2 and 0.1 C formation/0.2 C, and the results are shown in FIGS. 4 and 5.

FIG. 4 is a graph showing the capacity retention rate and Coulombic efficiency measurement results over 180 cycles at room temperature (25° C.) for the LFP∥Li secondary battery manufactured in Example 6. According to the results in FIG. 4, a high capacity retention rate of 84% and excellent Coulombic efficiency of 99% or more were exhibited over 180 cycles at room temperature. Through this, considering that most polymer electrolytes have an operating temperature of 60° C. or higher, it was found that the performance evaluation results of Example 6 are at a very excellent level.

FIG. 5 is a graph showing the results of specific capacity measurements at room temperature (25° C.) for the LFP∥Li secondary battery manufactured in Example 6. According to the results in FIG. 5, a high specific capacity of 167 mAh/gLFP was exhibited even at a high capacity of 3.8 mAh/cm2. Through this, it was found that Example 6 can increase the activity of the electrode and consequently exhibit a high specific capacity as the ion migration between the electrode and the electrolyte becomes active.

### Experimental Example 3: Small-Angle X-Ray Scattering (SAXS) Analysis

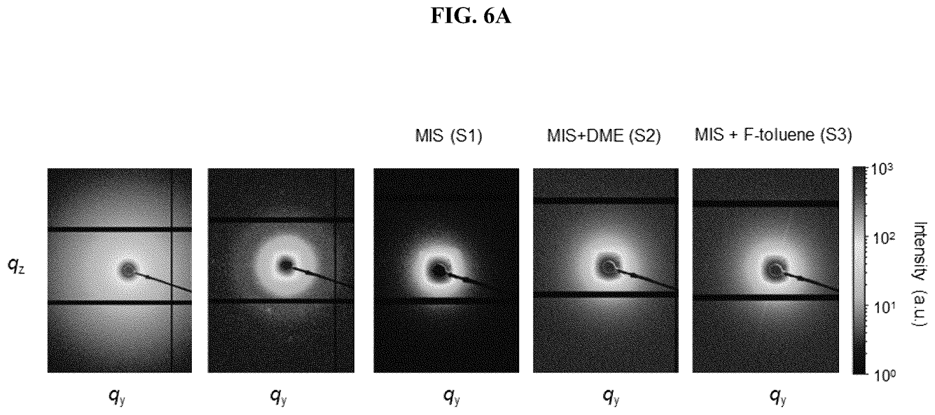

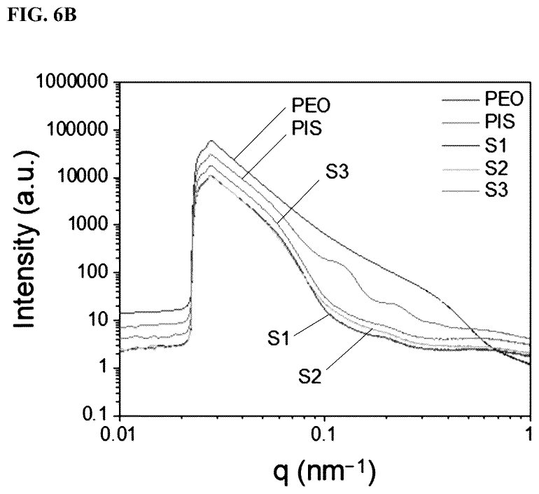

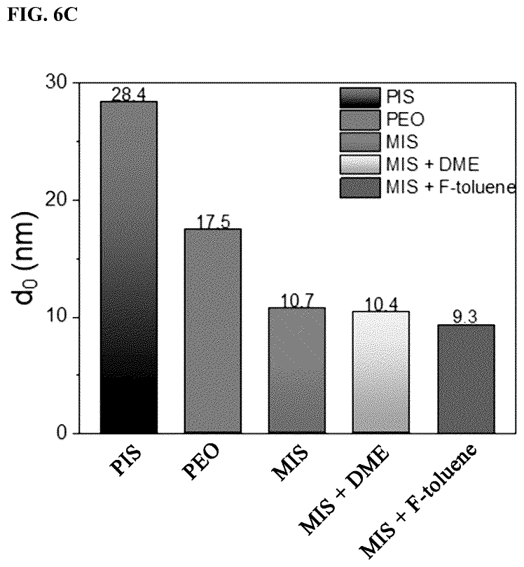

Small-angle X-ray scattering (SAXS) analysis was performed on the five electrolytes (PIS, PEO, MIS, MIS+DME, and MIS+F-toluene, respectively) manufactured in Control Examples 1 to 4 and Example 7, and the results were presented in FIGS. 6A and 6B. And, through calculations based on these results, domain sizes as shown in FIG. 6c were obtained.

The domains of the comparative examples show domain sizes approaching 30 nm in Comparative Example 1 in large cases, and exceeding 10 nm even in small cases, whereas in Example 7, domains smaller than 10 nm can be observed to be formed.

What is claimed is:

1. A polymer electrolyte composition comprising (i) a monomer including one or more double bonds, (ii) a carbonate-based compound, (iii) a lithium salt, and (iv) a dispersant.

2. The polymer electrolyte composition for a polymer electrolyte according to claim 1, wherein the polymer electrolyte composition further comprises an initiator.

3. The polymer electrolyte composition for a polymer electrolyte according to claim 1, wherein the monomer is an imide-based monomer.

4. The polymer electrolyte composition for a polymer electrolyte according to claim 1, wherein the dispersant is a dispersant that does not dissolve the monomer and the lithium salt.

5. The polymer electrolyte composition for a polymer electrolyte according to claim 1, wherein the dispersant has a dielectric constant of 10 or less.

6. The polymer electrolyte composition for a polymer electrolyte according to claim 2,
wherein the dispersant is one or more selected from the group consisting of trifluorotoluene (F-toluene), 1,1,2,2-tetrafluoroethyl-2,2,3,3-tetrafluoropropyl ether (TTE), 2,2-bis(trifluoromethyl)-1,3-dioxolane (TFDOL), trifluoroethyl phosphite (TFEPi), trifluoroethyl phosphate (TFEPa), 1,1,2,2-tetrafluoroethyl-2,2,2-trifluoroethyl ether, monofluorobenzene (FB), difluorobenzene, trifluorobenzene, tetrafluorobenzene, pentafluorobenzene, hexafluorobenzene, 1,1,2,2-tetrafluoro-3-(1,1,2,2-tetrafluoroethoxy)propane, methyl difluoroacetate ethyl difluoroacetate, and difluoroethyl acetate; and the monomer is one or more selected from the group consisting of 1-ethyl-3-methylimidazolium bis(trifluoromethylsulfonyl)imide, N-methyl-N-propylpyrrolidinium bis(trifluoromethanesulfonyl)imide, N-butyl-N-methylpyrrolidium bis(3-trifluoromethylsulfonyl)imide, and 1-butyl-3-methylimidazolium bis(trifluoromethylsulfonyl)imide;
the carbonate-based compound is one or more selected from the group consisting of allyl methylene carbonate, allyl ethylene carbonate, divinyl carbonate, vinylene carbonate, vinylethylene carbonate, and vinylmethyl carbonate;
the lithium salt is one or more selected from the group consisting of LiPF6, LiBF4, LiSbF6, LiAsF6, LiGO, LiFSI, LiCl, LiBr, LiI, LiB10Cl10, LiCF3SO3, LiCF3CO2, LiAlCl4, CH3SO3Li, LiSCN, LiOH·H2O, LiBOB, LiN(C2F5SO2)2, LiN(CF3SO2)2, CF3SO3Li, LiC(CF3SO2)3, LiC4BO8, LiTFSI, and LiClO4; and
the initiator is one or more selected from the group consisting of azobisisobutyronitrile (AIBN), azobisdimethylvaleronitrile (ADMVN), dilauroyl peroxide (DLP), benzoyl peroxide (BPO), acetyl peroxide, t-butyl peracetate, cumyl peroxide, t-butyl peroxide, t-butyl hydroperoxide, and bis(4-tert-butylcyclohexyl) peroxydicarbonate.

7. The polymer electrolyte composition for a polymer electrolyte according to claim 1,
wherein the molar ratio of the monomer:the carbonate-based compound is 1:2-6, and
the molar ratio of (the monomer+the carbonate-based compound):the lithium salt is 1-3:1.

8. The polymer electrolyte composition for a polymer electrolyte according to claim 1, wherein the dispersant is included in an amount of 10-50 vol % based on 100 vol % of the mixed volume of (the monomer+the carbonate-based compound+the lithium salt).

9. The polymer electrolyte composition for a polymer electrolyte according to claim 1,
wherein the dispersant is trifluorotoluene or 1,1,2,2-tetrafluoroethyl-2,2,3,3-tetrafluoropropyl ether, and
the content of the trifluorotoluene is 15-25 vol % or the content of the 1,1,2,2-tetrafluoroethyl-2,2,3,3-tetrafluoropropyl ether is 35-45 vol % based on 100 vol % of the mixed volume of (the monomer+the carbonate-based compound+the lithium salt).

10. The polymer electrolyte composition for a polymer electrolyte according to claim 2, wherein the initiator is included in an amount of 1-5 wt % based on 100 wt % of the mixed weight of (the monomer+the carbonate-based compound).

11. A polymer electrolyte comprising: \textcircled{1} a polymer obtained by polymerizing a monomer including one or more double bonds and a carbonate-based compound; \textcircled{2} a lithium salt; and \textcircled{3} a dispersant.

12. The polymer electrolyte according to claim 11, wherein the monomer is an imide-based monomer.

13. The polymer electrolyte according to claim 11, wherein the dispersant is a dispersant that does not dissolve the monomer and the lithium salt.

14. The polymer electrolyte according to claim 11, wherein the dispersant has a dielectric constant of 10 or less.

15. The polymer electrolyte according to claim 11,
wherein the dispersant is one or more selected from the group consisting of trifluorotoluene (F-toluene), 1,1,2,2-tetrafluoroethyl-2,2,3,3-tetrafluoropropyl ether (TTE), 2,2-bis(trifluoromethyl)-1,3-dioxolane (TFDOL), trifluoroethyl phosphite (TFEPi), trifluoroethyl phosphate (TFEPa), 1,1,2,2-tetrafluoroethyl-2,2,2-trifluoroethyl ether, monofluorobenzene (FB), difluorobenzene, trifluorobenzene, tetrafluorobenzene, pentafluorobenzene, hexafluorobenzene, 1,1,2,2-tetrafluoro-3-(1,1,2,2-tetrafluoroethoxy)propane, methyl difluoroacetate ethyl difluoroacetate, and difluoroethyl acetate;
the monomer is one or more selected from the group consisting of 1-ethyl-3-methylimidazolium bis(trifluoromethylsulfonyl)imide, N-methyl-N-propylpyrrolidinium bis(trifluoromethanesulfonyl)imide, N-butyl-N-methylpyrrolidium bis(3-trifluoromethylsulfonyl)imide, and 1-butyl-3-methylimidazolium bis(trifluoromethylsulfonyl)imide;
the carbonate-based compound is one or more selected from the group consisting of allyl methylene carbonate, allyl ethylene carbonate, divinyl carbonate, vinylene carbonate, vinylethylene carbonate, and vinylmethyl carbonate; and
the lithium salt is one or more selected from the group consisting of LiPF6, LiBF4, LiSbF6, LiAsF6, LiGO, LiFSI, LiCl, LiBr, LiI, LiB10Cl10, LiCF3SO3, LiCF3CO2, LiAlCl4, CH3SO3Li, LiSCN, LiOH·H2O, LiBOB, LiN(C2F5SO2)2, LiN(CF3SO2)2, CF3SO3Li, LiC(CF3SO2)3, LiC4BO8, LiTFSI, and LiClO4.

16. The polymer electrolyte according to claim 11, wherein the molar ratio of the monomer:the carbonate-based compound is 1:2-6.

17. The polymer electrolyte according to claim 11, wherein the molar ratio of (the monomer+the carbonate-based compound):the lithium salt is 1-3:1.

18. The polymer electrolyte according to claim 11, wherein the dispersant is included in an amount of 10-50 vol % based on 100 vol % of the mixed volume of (the monomer+the carbonate-based compound+the lithium salt).

19. The polymer electrolyte according to claim 11,
wherein the thickness of the polymer electrolyte is 20-100 μm, and
the ionic conductivity of the polymer electrolyte is 2.8×10⁴ to 3.0×10⁻³ S/cm at 25° C.

20. The polymer electrolyte according to claim 11, wherein the polymer electrolyte has a domain size of less than 10 nm according to small-angle X-ray scattering (SAXS) analysis.

21. The polymer electrolyte according to claim 11,
wherein the monomer is 1-ethyl-3-methylimidazolium bis(trifluoromethylsulfonyl)imide,
the carbonate-based compound is vinylethylene carbonate,
the molar ratio of the monomer:the carbonate-based compound is 1:3-5,
the molar ratio of (the monomer+the carbonate-based compound):lithium salt is 1.3-2.8:1 molar ratio, and
the dispersant is trifluorotoluene (F-toluene) or 1,1,2,2-tetrafluoroethyl-2,2,3,3-tetrafluoropropyl ether (TTE).

22. A separator for a lithium secondary battery comprising the polymer electrolyte according to claim 11.

23. A lithium secondary battery comprising the polymer electrolyte according to claim 11.

24. A device comprising the lithium secondary battery of claim 23, wherein the device is any one selected from a communication device, a transportation device, and an energy storage device.
